(19) United States
(12) Patent Application Publication
(10) Pub. No.: US 2018/0224199 A1
(43) Pub. Date: Aug. 9, 2018

(54) METHOD OF MANUFACTURING THERMAL INSULATING PROFILE AND THERMAL INSULATING PROFILE

(71) Applicant: YKK AP Inc., Tokyo (JP)

(72) Inventors: Ryuichiro Mizuno, Tokyo (JP); Akiyuki Kuriyama, Tokyo (JP); Tomoaki Eguchi, Tokyo (JP)

(21) Appl. No.: 15/729,804

(22) Filed: Oct. 11, 2017

(30) Foreign Application Priority Data
Feb. 6, 2017 (JP) 2017-019725

(51) Int. Cl. F25D 23/06; B23P 19/04; B29C 31/08; B29C 33/02

(52) U.S. Cl. CPC F25D 23/066; B29C 33/02; B29C 31/08; B23P 19/04

(57) ABSTRACT

A thermal insulating profile includes: a metal profile including a first profile portion, a second profile portion, and a cavity forming portion in which an injection port along a longitudinal direction of the first profile portion and the second profile portion is formed and in which a cavity communicated with the injection port is formed between the first profile portion and the second profile portion, the cavity forming portion including a portion on a first profile portion side and a portion on a second profile portion side that are disposed with a gap therebetween; and a thermal insulating material formed from a foaming resin material and disposed in the cavity.

### CROSS-REFERENCE TO RELATED APPLICATIONS

The present application claims priority to and incorporates by reference the entire contents of Japanese Patent Application No. 2017-019725 filed in Japan on Feb. 6, 2017.

### BACKGROUND

### 1. Technical Field

The disclosure relates to a thermal insulating profile and a method of manufacturing a thermal insulating profile.

### 2. Related Art

In the related art, a thermal insulating profile in which an outdoor member and an indoor member are coupled to each other through only a thermal insulating material made of urethane resin is known as a thermal insulating profile that can be used as a window frame and a stile member (see Japanese Laid-open Patent Publication No. 9-291756).

The thermal insulating profile is manufactured as follows. First, a profile in which an outdoor member and an indoor member are connected through a coupling portion is integrally molded. Next, a urethane resin material in a liquid state is injected into an injection packet portion (cavity) having a concave groove shape formed in the coupling portion. After the urethane resin material cures, the coupling portion is cut and removed. In this manner, the thermal insulating profile is obtained.

### SUMMARY

In the manufacturing of the thermal insulating profile described in Japanese Laid-open Patent Publication No. 9-291756, an opening surface of the cavity filled with the urethane resin material is not closed but is left until the urethane resin material cures. Thus, in the case where a nonfoamable resin material is injected into a cavity, the resin material can cure without protruding from an injection port of the cavity. However, in the case where a foaming resin material, which is foamed when curing, is injected into a cavity, the foaming resin material protrudes from an injection port of the cavity, and it is difficult to manufacture a thermal insulating profile.

It is an object of the disclosure to at least partially solve the problems in the conventional technology.

According to one aspect of the disclosure, a method of manufacturing a thermal insulating profile, the method includes: preparing a metal profile including a first profile portion, a second profile portion, and a cavity forming portion in which an injection port along a longitudinal direction of the first profile portion and the second profile portion is formed and in which a cavity communicated with the injection port is formed between the first profile portion and the second profile portion; injecting a foaming resin material into the cavity through the injection port; closing the injection port with a closing tool; foaming and curing the foaming resin material to form a thermal insulating material; and then dividing the cavity forming portion into a portion on a first profile portion side and a portion on a second profile portion side to form a gap therebetween.

In the method of manufacturing the thermal insulating profile in the disclosure, the injection port is closed with the closing tool after the foaming resin material is injected into the cavity. Thus, the foaming resin material, which is foamed when curing, can be prevented from protruding from the injection port, and hence a thermal insulating profile including a thermal insulating material obtained by foaming and curing the foaming resin material can be manufactured.

Because the foaming resin material having foaming and curing properties is injected into the cavity, the amount of injection into the cavity can be reduced depending on the expansion ratio of the foaming resin material, and the time necessary to inject the foaming resin material can be further reduced.

In the method of manufacturing the thermal insulating profile according to another aspect of the disclosure, the metal profile may be formed from an aluminum extruded profile, the foaming resin material to be injected into the cavity may have an expansion ratio of 3 to 5, and a filling ratio of the foaming resin material with respect to the cavity may be 50% to 60% before the foaming resin material is foamed and cured.

For example, when a foaming resin material having an expansion ratio of 6 to 8 is injected into the cavity at a filling ratio of 30% to 70% (or 70% or more), the resin strength of a thermal insulating material obtained when the foaming resin material is foamed and cures may be poor (resin strength lower than that necessary for coupling the first profile portion and the second profile portion to each other is regarded as a resin strength defect), the foaming resin material may protrude from the injection port in the aluminum profile or the aluminum profile may be pressed and deformed because of foaming of the foaming resin material. In the disclosure, on the other hand, a resin strength defect of the thermal insulating material, the protrusion of the foaming resin material from the injection port in the aluminum profile, and the deformation of the aluminum profile caused when the aluminum profile is pressed because of the foaming of the foaming resin material can be eliminated.

For example, when a foaming resin material having an expansion ratio of 3 to 5 is injected into the cavity at a filling ratio of 30% (or 30% or less), the cavity cannot necessarily be filled with the foaming resin material because of foaming of the foaming resin material or the density of the foaming resin material may be decreased and the curing thermal insulating material may have a resin strength defect. In addition, also when a foaming resin material having an expansion ratio of 3 to 5 is injected into the cavity at a filling ratio of 40%, the curing thermal insulating material may have poor resin strength. In the disclosure, on the other hand, the density of the foaming resin material can be increased as long as the aluminum profile is not deformed when the aluminum profile is pressed because of the foaming of the foaming resin material. The resin strength of the thermal insulating material after the foaming resin material cures can be increased to be equal to or higher than the resin strength necessary for coupling the first profile portion and the second profile portion to each other.

In the method of manufacturing the thermal insulating profile according to still another aspect of the disclosure, the closing tool may include a jig having a closing surface to which a fluorinated coating is applied or a jig having a closing portion formed from a fluorinated resin material.

With this configuration, after the foaming resin material cures, the closing surface or the closing portion of the jig can be easily peeled off from the surface of the thermal insulating material, and the surface of the thermal insulating material can be prevented from being roughened. Because the jig can be easily peeled off from the thermal insulating material, the jig can be re-used at a step for closing an injection port in another metal profile.

The method of manufacturing the thermal insulating profile according to further another aspect of the disclosure may further include pre-heating the metal profile; and performing discharge treatment on a surface of the pre-heated metal profile where the cavity is formed, and thereafter injecting the foaming resin material into the cavity.

With this configuration, the metal profile is pre-heated, and hence the foaming resin material injected into the cavity in the metal profile is not quickly cooled by the metal profile, but the foaming resin material can be expanded evenly in the cavity and cure.

By performing discharge treatment on the surface of the metal profile in which the cavity is to be formed, the curing thermal insulating material can be more firmly bonded to the metal profile.

According to one aspect of the disclosure, a thermal insulating profile includes: a metal profile including a first profile portion, a second profile portion, and a cavity forming portion in which an injection port along a longitudinal direction of the first profile portion and the second profile portion is formed and in which a cavity communicated with the injection port is formed between the first profile portion and the second profile portion, the cavity forming portion including a portion on a first profile portion side and a portion on a second profile portion side that are disposed with a gap therebetween; and a thermal insulating material formed from a foaming resin material and disposed in the cavity.

The thermal insulating profile in the disclosure can be manufactured by the above-mentioned method of manufacturing the thermal insulating profile in the disclosure, and can exhibit the above-mentioned functions and effects.

In the thermal insulating profile according to another aspect of the disclosure, the thermal insulating material may be formed from a foaming resin material having an expansion ratio of 3 to 5.

This configuration employs the foaming resin material to be injected through the injection port, which has an expansion ratio (expansion ratio in free state) of 3 to 5, and hence can reduce the amount of injection as compared with the case where a nonfoamable resin material is employed. A low-foaming resin material having an expansion ratio smaller than that of a general foaming resin material (such as a hard urethane foam having a free expansion ratio of 30 or more (density of 25 kg/m³)) cures, and hence a thermal insulating material having strength necessary as a construction member can be formed.

The above-mentioned foaming resin material in the disclosure can improve thermal insulating performance as compared with the case where a nonfoamable resin material is employed.

Specifically, the foaming resin material has a smaller amount of strain generated inside a molded product than a nonfoamable resin material, and hence after the foaming resin material is foamed and cures, the amount of resin shrinkage (dry shrinkage) is reduced. In the foaming resin material, the resin itself functions as a stress buffer, and hence an interface stress between the aluminum profile and the foaming resin material is reduced. Thus, the force acting in the direction in which the foaming resin material shrinks along the longitudinal direction of the thermal insulating profile after the foaming resin material is foamed and cures can be reduced to suppress the occurrence of deformation such as warpage and bending of the thermal insulating profile and cracks of the thermal insulating material.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a sectional view illustrating a thermal insulating profile manufactured by an embodiment of the disclosure;

FIG. 2 is a flowchart illustrating a manufacturing procedure according to the embodiment;

FIG. 3A is a sectional view illustrating an aluminum profile at a preparation/pre-heating step in the embodiment;

FIG. 3B is a sectional illustrating the aluminum profile at a surface treatment step in the embodiment;

FIG. 4A is a sectional view illustrating the aluminum profile at an injection step in the embodiment;

FIG. 4B is a sectional view illustrating the aluminum profile at a closing step in the embodiment;

FIG. 5A is a sectional view illustrating the aluminum profile at a curing step in the embodiment;

FIG. 5B is a sectional view illustrating the aluminum profile at an opening step in the embodiment; and

FIG. 6 is a sectional view illustrating an aluminum profile at a closing step in a modification of the disclosure.

### DETAILED DESCRIPTION

### Configuration in the Present Embodiment

Embodiments of the disclosure are described below with reference to the accompanying drawings.

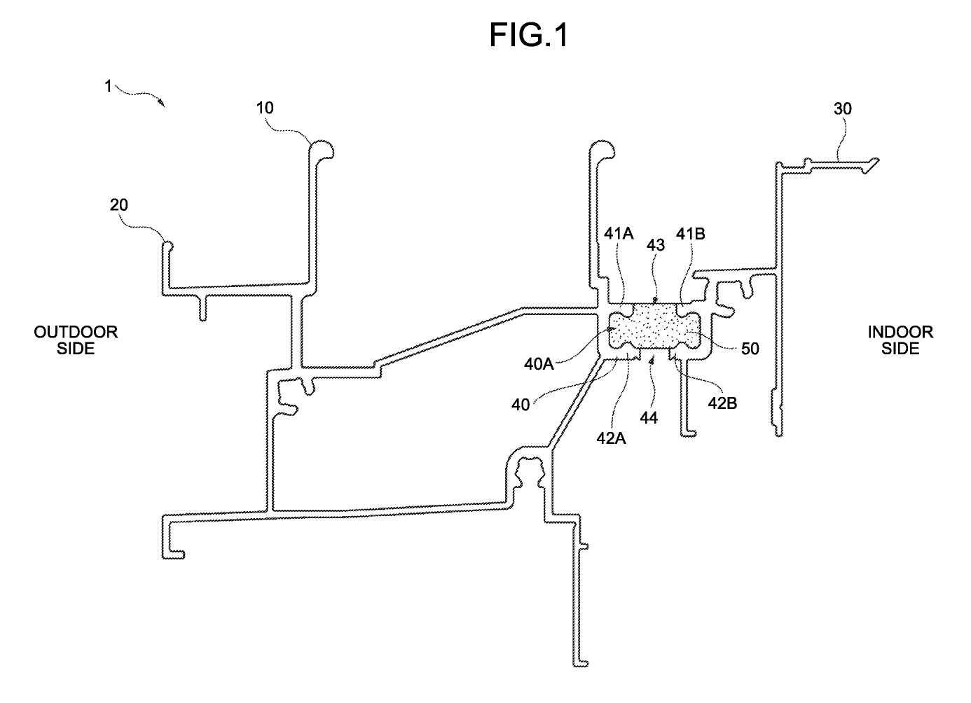

In FIG. 1, a thermal insulating profile 1 according to an embodiment of the disclosure is used as frame materials and stile materials for various kinds of sash windows. The thermal insulating profile 1 includes an aluminum profile 10 as a metal profile including a first profile portion 20 on the outdoor side, a second profile portion 30 on the indoor side, and a cavity forming portion 40. In a cavity 40A formed in the cavity forming portion 40, a thermal insulating material 50 is disposed, and the first profile portion 20 and the second profile portion 30 are coupled to each other through the thermal insulating material 50.

The aluminum profile 10 is formed of an aluminum extruded profile. The cavity forming portion 40 is divided into a portion on the first profile portion 20 side and a portion on the second profile portion 30 side such that an injection port 43 and a gap 44 described later are formed. In this manner, the aluminum profile 10 is partitioned into an outdoor member and an indoor member.

The cavity forming portion 40 includes a pair of extended piece portions 41A and 42A that are extended from the indoor-side portion of the first profile portion 20 to the indoor side and a pair of extended piece portions 41B and 42B that are extended from the outdoor-side portion of the second profile portion 30 to the outdoor side.

The injection port 43 along the longitudinal direction of the first profile portion 20 and the second profile portion 30 is formed between the extended piece portions 41A and 41B.

The gap 44 along the longitudinal direction of the first profile portion 20 and the second profile portion 30 is formed between the extended piece portions 42A and 42B.

An indoor-side part of the first profile portion 20, the extended piece portions 41A and 42A, an outdoor-side part of the second profile portion 30, and the extended piece portions 41B and 42B each have a thickness dimension of 1.0 mm or more, preferably 1.4 to 2.0 mm.

The cavity 40A is formed by surfaces of the indoor-side portion of the first profile portion 20 and the extended piece portions 41A and 42A and surfaces of the outdoor-side portion of the second profile portion 30 and the extended piece portions 41B and 42B. In the present embodiment, the cavity 40A has a sectional area of 40 mm² or more, preferably 60 to 2,000 mm².

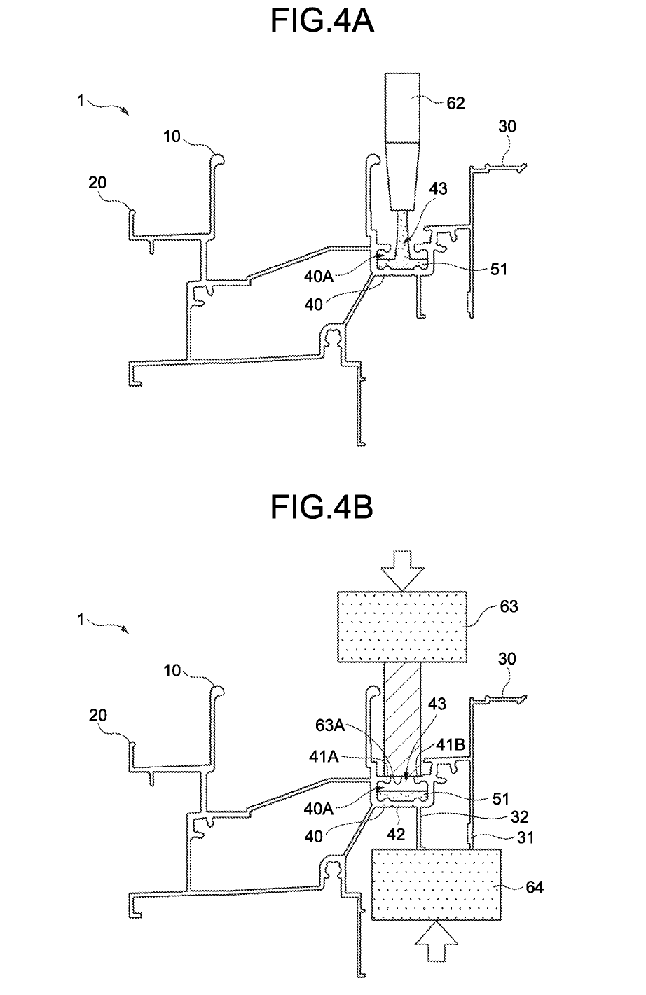

The thermal insulating material 50 in the present embodiment is formed by foaming and curing a foaming resin material 51 (see FIG. 4) whose expansion ratio in a free state is 3 to 5 in the cavity 40A. The foaming resin material 51 is made of a foamable urethane resin material in a liquid state. The thermal insulating material 50 has a tensile strength of 3 MPa or more as the resin strength necessary for coupling the first profile portion 20 and the second profile portion 30 to each other.

The thermal insulating profile 1 (thermal insulating aluminum profile) described above has a configuration in which the first profile portion 20 and the second profile portion 30 are partitioned from each other and are connected to each other through the thermal insulating material 50. Thus, heat transfer between the first profile portion 20 and the second profile portion 30 is interrupted by the thermal insulating material 50.

Method of Manufacturing Thermal Insulating Profile

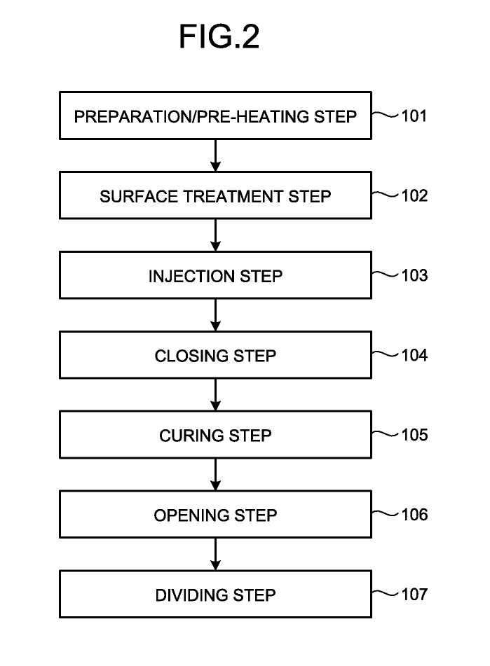

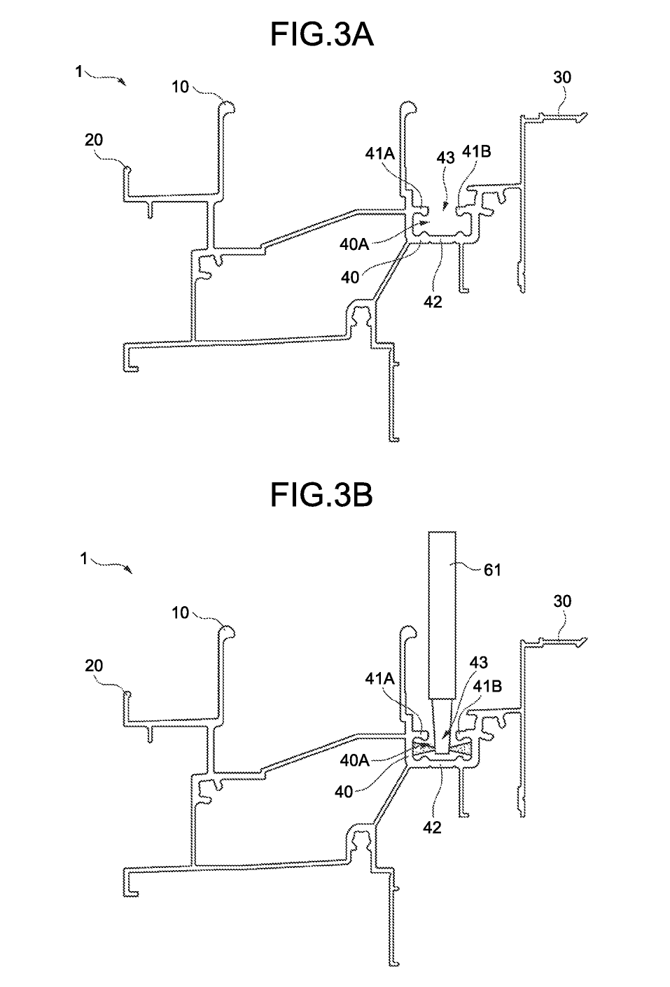

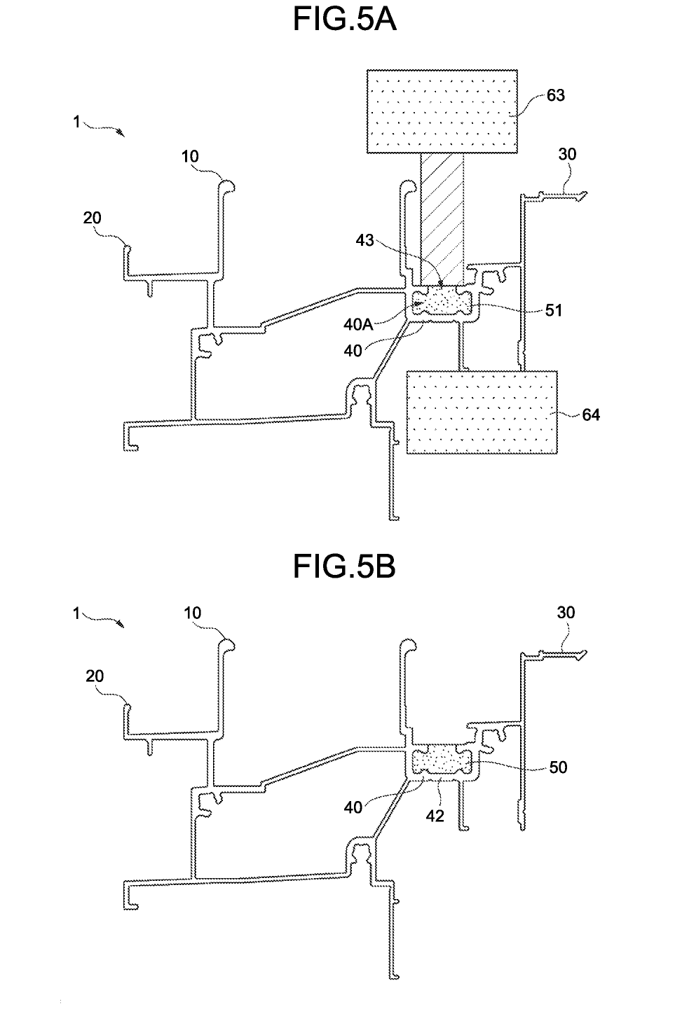

Referring to FIG. 2, FIG. 3A, FIG. 3B, FIG. 4A, FIG. 4B, FIG. 5A, and FIG. 5B, a method of manufacturing a thermal insulating profile according to the present embodiment is described below.

The thermal insulating profile 1 is manufactured through steps illustrated in FIG. 2, specifically, a preparation/pre-heating step 101 for preparing and pre-heating an aluminum profile 10, a surface treatment step 102 for treating the surface of a cavity forming portion 40, an injection step 103 for injecting a foaming resin material 51, a closing step 104 for closing an injection port 43, a curing step 105 for curing the foaming resin material 51, an opening step 106 for opening the injection port 43, and a dividing step 107 for dividing the aluminum profile 10.

At the preparation/pre-heating step 101, the aluminum profile 10 is disposed at a predetermined position for preparation. In the aluminum profile 10, as illustrated in FIG. 3A, the injection port 43 is formed between the extended piece portions 41A and 41B, but the extended piece portions 42A and 42B are not divided and a continuous piece portion 42 is formed. Thus, the first profile portion 20 and the second profile portion 30 are continuous through a continuous piece portion 42. The prepared aluminum profile 10 is pre-heated to 40° C. or more.

At the surface treatment step 102, as illustrated in FIG. 3B, a surface of the aluminum profile 10 where the cavity 40A is to be formed is subjected to surface modification by discharge treatment such as corona discharge treatment and plasma discharge treatment by using a surface treatment device 61. The surface where the cavity 40A is to be formed is defined by an indoor surface of the indoor-side portion of the first profile portion 20, an outdoor surface of the outdoor-side portion of the second profile portion 30, inner surfaces of the extended piece portions 41A and 41B, and an inner surface of the continuous piece portion 42.

At the injection step 103, as illustrated in FIG. 4A, the foaming resin material 51 in the liquid state is injected into the cavity 40A through the injection port 43 by using an injection device 62. In the present embodiment, the filling ratio of the foaming resin material 51 with respect to the cavity 40A falls within the range of 50% to 60%.

At the closing step 104, as illustrated in FIG. 4B, the injection port 43 is closed with a closing tool 63 and a profile receiving tool 64. The closing tool 63 is configured by a jig having a closing surface 63A to which a fluorocarbon-based coating is applied. The closing surface 63A closes the injection port 43 when brought into contact with the outer surfaces of the extended piece portions 41A and 41B. In the present embodiment, the profile receiving tool 64 abuts on a front piece portion 31 of the second profile portion 30 and a drooping piece portion 32 that droops from the cavity forming portion 40, thereby receiving the continuous piece portion 42 of the cavity forming portion 40. At this time, the cavity forming portion 40 is clamped by the closing tool 63 and the profile receiving tool 64.

The closing tool 63 may be configured by a jig having a closing portion formed from a fluorocarbon-based polymer, instead of the jig having the closing surface 63A to which a fluorocarbon-based coating is applied as described above.

At the curing step 105, the foaming resin material 51 is left for about 10 minutes while the above-mentioned clamped state is being kept. During the leaving time, the foaming resin material 51 cures while generating heat by itself. In this case, the foaming resin material 51 is foamed, and the cavity 40A is filled with the foaming resin material 51 as illustrated in FIG. 5A. The injection port 43 is closed with the closing tool 63, and hence the foaming resin material 51 is prevented from protruding from the injection port 43. The cavity forming portion 40 is clamped by the closing tool 63 and the profile receiving tool 64, and hence the cavity forming portion 40 is prevented from being deformed by being pressed by the foaming resin material 51 when the foaming resin material 51 is foamed.

At the opening step 106, after the foaming resin material 51 is foamed and cures, the closing tool 63 and the profile receiving tool 64 are detached from the aluminum profile 10 to open the injection port 43, resulting in the state illustrated in FIG. 5B. At this time, the foaming resin material 51 is the curing thermal insulating material 50.

At the dividing step 107, the continuous piece portion 42 is cut such that the cavity forming portion 40 is divided into a portion on the first profile portion 20 side and a portion on the second profile portion 30 side to form the gap 44 between the extended piece portions 42A and 42B as illustrated in FIG. 1. Consequently, the thermal insulating profile 1 in which the first profile portion 20 and the second profile portion 30 are partitioned from each other and are coupled to each other through the thermal insulating material 50 is formed.

In this manner, the thermal insulating profile 1 is manufactured.

### Example

An example of the disclosure is described below.

In the method of manufacturing the thermal insulating profile described above, foaming resin materials 51 having expansion ratios in a free state of 3 to 8 were injected into the cavity 40A at filling ratios of 30% to 70% to execute the injection step 103 and manufacture thermal insulating profiles 1, and the finished states and the resin strengths of the thermal insulating materials 50 were compared. The finished state of the thermal insulating material 50 was evaluated as satisfactory when there was no insufficient filling of the thermal insulating material 50 in the cavity 40A, no protrusion of the thermal insulating material 50 from the injection port 43, or no deformation of the aluminum profile 10, and evaluated as poor when such defects occurred. The resin strength of the thermal insulating material 50 was evaluated as satisfactory when the tensile strength was 3 MPa or more, and evaluated as poor when the tensile strength was less than 3 MPa. The results of the comparison are as illustrated in Table 1 indicating the relation between the free expansion ratio (free foam density) of the foaming resin material 51 and the filling ratio of the foaming resin material 51.

TABLE 1

| | | Filling ratio | | | | |
|---|---|---|---|---|---|---|
| | | ≤30% | 40% | 50% | 60% | 70%≤ |
| Free | 3 to 5 | C | B | A | A | C |
| expansion | (400 to 220 kg/m³) | | | | | |
| ratio | 6 to 8 | C | C | C | C | C |
| (free foam | (220 to 140 kg/m³) | | | | | |
| density) | | | | | | |

As illustrated in Table 1, when a foaming resin material 51 having a free expansion ratio of 3 to 5 (free foam density of 400 to 220 kg/m³) was injected into the cavity 40A at a filling ratio of 50% or 60% and cured, it was evaluated that the finished state of the thermal insulating material 50 was satisfactory and the resin strength was also satisfactory. This result was expressed as “A”.

When a foaming resin material 51 having a free expansion ratio of 3 to 5 (free foam density of 400 to 220 kg/m³) was injected into the cavity 40A at a filling ratio of 40% and cured, it was evaluated that the finished state of the thermal insulating material 50 was satisfactory while the resin strength was satisfactory in some parts and poor in other parts. This result was expressed as “B”.

When a foaming resin material 51 having a free expansion ratio of 3 to 5 (free foam density of 400 to 220 kg/m³) was injected into the cavity 40A at a filling ratio of 30% and cured, a finished state defect and a resin strength defect occurred due to insufficient filling of the thermal insulating material 50 in the cavity 40A. This result was evaluated as poor and was expressed as “C”.

When a foaming resin material 51 having a free expansion ratio of 3 to 5 (free foam density of 400 to 220 kg/m³) was injected into the cavity 40A at a filling ratio of 70% and cured and when a foaming resin material 51 having a free expansion ratio of 6 to 8 (free foam density of 220 to 140 kg/m³) was injected into the cavity 40A at a filling ratio of 30%, 40%, 50%, 60%, or 70% and cured, finished state defects such as the protrusion of the thermal insulating material 50 from the injection port 43 and the deformation of the aluminum profile 10 and a resin strength defect occurred. This result was evaluated as poor and was expressed as “C”.

### Effects in the Present Embodiment

(1) In the present embodiment, the method of manufacturing a thermal insulating profile includes: preparing the aluminum profile 10 including the first profile portion 20, the second profile portion 30, and the cavity forming portion 40 in which the injection port 43 along the longitudinal direction of the first profile portion 20 and the second profile portion 30 is formed and in which the cavity 40A communicated with the injection port 43 is formed between the first profile portion 20 and the second profile portion 30; injecting the foaming resin material 51 into the cavity 40A through the injection port 43; closing the injection port 43 with the closing tool 63; foaming and curing the foaming resin material 51 to form the thermal insulating material 50; and then dividing the cavity forming portion 40 into a portion on the first profile portion 20 side and a portion on the second profile portion 30 side to form the gap 44.

With the above-mentioned configuration, after the foaming resin material 51 is injected into the cavity 40A, the injection port 43 is closed with the closing tool 63. Consequently, the foaming resin material 51, which is foamed when curing, can be prevented from protruding from the injection port 43, and hence the thermal insulating profile 1 including the thermal insulating material 50 obtained by foaming and curing the foaming resin material 51 can be manufactured.

When the foaming resin material 51 having foaming and curing properties is injected into the cavity 40A, the amount of injection into the cavity 40A can be reduced depending on the expansion ratio of the foaming resin material 51, and thus the time necessary to inject the foaming resin material 51 can be further reduced.

Furthermore, the present embodiment can exhibit the following effects.

(2) The foaming resin material 51 to be injected into the cavity 40A has an expansion ratio of 3 to 5, and the filling ratio of the foaming resin material 51 with respect to the cavity 40A is 50% to 60% before the foaming resin material is foamed and cured.

This can eliminate a resin strength defect in the thermal insulating material 50, the protrusion of the foaming resin material 51 from the injection port 43 in the aluminum profile 10, and the deformation of the aluminum profile 10 caused when the aluminum profile 10 is pressed because of the foaming of the foaming resin material 51.

By employing the foaming resin material 51 having an expansion ratio of 3 to 5 as the foaming resin material injected through the injection port 43, the amount of injection can be reduced as compared with the case where a nonfoamable resin material is employed.

The density of the foaming resin material 51 can be increased as long as the aluminum profile 10 is not deformed when the aluminum profile 10 is pressed because of the foaming of the foaming resin material 51. Thus, the resin strength of the thermal insulating material 50 after the foaming resin material 51 cures can be increased to be equal to or higher than the resin strength necessary for coupling the first profile portion 20 and the second profile portion 30 to each other (strength necessary for a construction member).

(3) The closing tool 63 includes the jig having the closing surface 63A to which a fluorocarbon-based coating is applied (or a jig having a closing portion formed from a fluorocarbon-based polymer).

Thus, after the foaming resin material 51 cures, the closing surface 63A or the closing portion of the jig can be easily peeled off from the surface of the thermal insulating material 50, and the surface of the thermal insulating material 50 can be prevented from being roughened. Because the jig can be easily peeled off from the thermal insulating material, the jig can be re-used at a step for closing an injection port in another metal profile.

(4) The method of manufacturing a thermal insulating profile further includes: pre-heating the aluminum profile 10; and performing discharge treatment on a surface of the pre-heated aluminum profile 10 where the cavity 40A is formed, and thereafter injecting the foaming resin material 51 into the cavity 40A.

The aluminum profile 10 is thus pre-heated, the foaming resin material 51 injected into the cavity 40A in the aluminum profile 10 is not quickly cooled by the aluminum profile 10, and the foaming resin material 51 can be expanded evenly in the cavity 40A and cure.

By performing the discharge treatment on the surface of the aluminum profile 10 where the cavity 40A is formed, the curing thermal insulating material 50 can be more firmly bonded to the aluminum profile 10.

Modifications

The disclosure is not limited to the configuration described in the above-mentioned embodiment, and such modifications that can achieve the object of the disclosure are included in the disclosure.

For example, in the above-embodiment, the metal profile is formed from an aluminum extruded profile formed from an extruded profile made of aluminum. Without being limited thereto, the metal profile may be made of iron, steel, stainless steel, or magnesium.

In the above-mentioned embodiment, the foaming resin material 51 whose expansion ratio in the free state is 3 to 5 is injected into the cavity 40A at a filling ratio of 50% to 60%. Without being limited thereto, the expansion ratio and the filling ratio may be freely selected as long as a finished state defect and a resin strength defect do not occur in the thermal insulating material 50. For example, a foaming resin material 51 whose expansion ratio in the free state is less than 3 or more than 5 may be injected into the cavity 40A depending on the metal material of the metal profile or the thickness dimension of a part of the metal profile in which the cavity 40A is formed. The filling ratio of the foaming resin material 51 with respect to the cavity 40A may be less than 50% or more than 60%.

In the above-mentioned embodiment, the closing tool 63 includes the jig having the closing surface 63A to which a fluorocarbon-based coating is applied (or a jig having a closing portion formed from a fluorocarbon-based polymer), but the embodiment is not limited thereto. As long as the closing tool 63 can be peeled off from the thermal insulating material 50 after the foaming resin material 51 cures, the closing surface 63A is not necessarily required to be coated with the above-mentioned fluorocarbon-based coating, or the closing portion is not necessarily required to be formed from the fluorocarbon-based polymer.

In the above-mentioned embodiment, the surface of the aluminum profile 10 where the cavity 40A is formed is subjected to surface treatment after the aluminum profile 10 is pre-heated. Without being limited thereto, the aluminum profile 10 may be pre-heated after the surface treatment is performed.

In the above-mentioned embodiment, the surface of the aluminum profile 10 where the cavity 40A is formed is subjected to both of corona discharge treatment and plasma discharge treatment, but the embodiment is not limited thereto. As long as the thermal insulating material 50 can be sufficiently bonded to the surface where the cavity 40A is formed, surface treatment of one of corona discharge treatment and plasma discharge treatment may be omitted, or both of the surface treatments may be omitted.

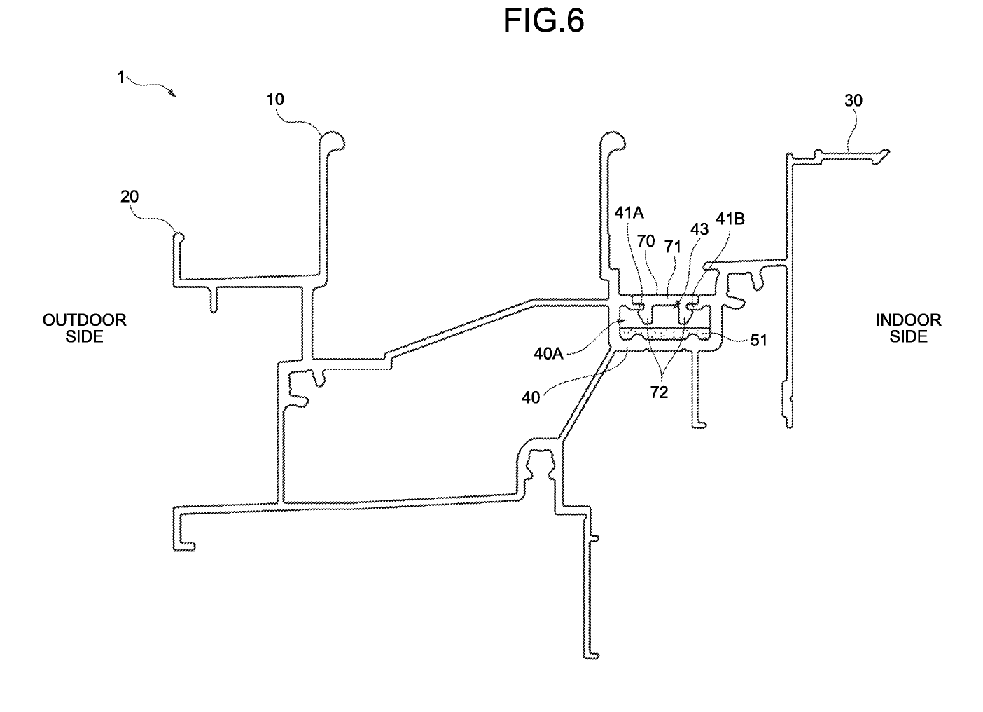

In the above-mentioned embodiment, the closing tool 63 and the profile receiving tool 64 are disposed at the closing step 104, but the embodiment is not limited thereto. For example, as illustrated in FIG. 6, a closing member 70 may be mounted to the injection port 43 at the closing step 104.

The closing member 70 is made of resin, and includes a closing body portion 71 disposed at the injection port 43 and a pair of engaging protrusions 72 as hooked portions that are hooked to the extended piece portions 41A and 41B of the cavity forming portion 40. The pair of engaging protrusions 72 are elastically deformable, and a claw portion is formed at each of distal end portions thereof. When the closing member 70 is pushed into the injection port 43 from the outside, the pair of engaging protrusions 72 are elastically deformed to be inserted into the cavity 40A, and the claw portions are engaged with the extended piece portions 41A and 41B. The closing member 70 is thus easily mounted in a snap-fit manner.

The outer surface of the closing body portion 71 exposed from the injection port 43 is subjected to finishing treatment, and the outer surface is disposed to be flush with the outer surfaces of the extended piece portions 41A and 41B.

When the closing member 70 is mounted as described above, the closing member 70 can prevent the foaming resin material 51 from protruding from the injection port 43 when the foaming resin material 51 is foamed. As compared with the case where the thermal insulating material 50 is exposed from the injection port 43, a surface part of the closing member 70 that is exposed from the injection port 43 can be subjected to finishing treatment in advance. Furthermore, the number of variations of the finished state can be increased through the selection of the material and the color of the closing member 70. In addition, the opening step 106 is unnecessary, and hence the manufacturing time can be reduced accordingly.

The thermal insulating profile 1 according to the above-mentioned embodiment is used as, for example, a frame member and a stile member for various kinds of sash windows in a building, such as a double sliding window, a single sliding window, a casement window, an awning window, an inward swinging window, an outward swinging window, a double hung window, an inward opening window, and an outward opening window, and also used as a frame member for construction members, such as a door and a louver.

According to the disclosure, a method of manufacturing a thermal insulating profile and a thermal insulating profile that are capable of reducing time necessary for injecting a foaming resin material can be provided.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of manufacturing a thermal insulating profile, the method comprising:
preparing a metal profile including a first profile portion, a second profile portion, and a cavity forming portion in which an injection port along a longitudinal direction of the first profile portion and the second profile portion is formed and in which a cavity communicated with the injection port is formed between the first profile portion and the second profile portion;
injecting a foaming resin material into the cavity through the injection port;
closing the injection port with a closing tool;
foaming and curing the foaming resin material to form a thermal insulating material; and then
dividing the cavity forming portion into a portion on a first profile portion side and a portion on a second profile portion side to form a gap therebetween.

2. The method of manufacturing a thermal insulating profile according to claim 1, wherein
the metal profile is formed from an aluminum extruded profile,
the foaming resin material to be injected into the cavity has an expansion ratio of 3 to 5, and
a filling ratio of the foaming resin material with respect to the cavity is 50% to 60% before the foaming resin material is foamed and cured.

3. The method of manufacturing a thermal insulating profile according to claim 1, wherein the closing tool includes a jig having a closing surface to which a fluorocarbon-based coating is applied or a jig having a closing portion formed from a fluorocarbon-based polymer.

4. The method of manufacturing a thermal insulating profile according to claim 1, further comprising:
pre-heating the metal profile; and
performing discharge treatment on a surface of the pre-heated metal profile where the cavity is formed, and thereafter injecting the foaming resin material into the cavity.

5. A thermal insulating profile comprising:
a metal profile including a first profile portion, a second profile portion, and a cavity forming portion in which an injection port along a longitudinal direction of the first profile portion and the second profile portion is formed and in which a cavity communicated with the injection port is formed between the first profile portion and the second profile portion, the cavity forming portion including a portion on a first profile portion side and a portion on a second profile portion side that are disposed with a gap therebetween; and
a thermal insulating material formed from a foaming resin material and disposed in the cavity.

6. The thermal insulating profile according to claim 5, wherein the thermal insulating material is formed from a foaming resin material having an expansion ratio of 3 to 5.
